(19) United States
(12) Patent Application Publication
(10) Pub. No.: US 2008/0033587 A1
(43) Pub. Date: Feb. 7, 2008

(54) A SYSTEM AND METHOD FOR MINING DATA FROM HIGH-VOLUME TEXT STREAMS AND AN ASSOCIATED SYSTEM AND METHOD FOR ANALYZING MINED DATA

(76) Inventors: Keiko Kurita, Los Gatos, CA (US); John K. Mann, Richmond, CA (US); Ross Nelson, Sunnyvale, CA (US); Tram T. Nguyen, San Jose, CA (US); Carlton W. Niblack, San Jose, CA (US); Zengyan Zhang, San Jose, CA (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/462,100

(22) Filed: Aug. 3, 2006

(51) Int. Cl. G06F 19/00

(52) U.S. Cl. 700/100

(57) ABSTRACT

Disclosed are embodiments of a method of mining data and a method of evaluating that data in order to discover significant changes in conditions (e.g., changes in activities, events, associations, affiliations, market preferences, etc.). The data mining technique uses predetermined scenarios that characterize specific changes as well as key variables that are relevant to those scenarios. These variables are input as mining parameters into a data mining tool. Retrieved data is analyzed and the results are evaluated. One technique of evaluating the results includes displaying them in a visual format (e.g., graphs, tables) along with additional information (e.g., lists of documents or portions of documents containing data relevant to the displayed results). A user evaluates the displayed results and additional information in order to identify data that should be filtered, to identify trends and/or patterns in the data, and to assess the trends and/or patterns.

### BACKGROUND

1. Field of the Invention

The embodiments of the invention generally relate to data mining, and, more particularly, to a system and method for efficiently and rapidly discovering important changes in the external environment by examining high-volume text streams as well as an associated system and method for efficiently analyzing such mined data.

2. Description of the Related Art

Organizations (e.g., government agencies, corporations, firms, associations, etc.) are often interested in conditions (e.g., events, activities, associations, market preferences, affiliations, the financial status of a competitor, etc.). Changes in these conditions may be beneficial or harmful to an organization. For example, shifts in market preferences, priorities, or beliefs may advantageously or adversely affect a business so early notification of shifts can be help an organization respond accordingly. At some point, every significant market shift becomes abundantly clear. An early discovery of the shift may create a window of opportunity that can be exploited if acted upon quickly enough. Therefore, one goal of an organization is not simply to spot these shifts, but rather to spot them earlier than other organizations and to spot them in an efficient manner.

Over the past ten years an increasing portion of written news and personal communication has shifted from paper-based media (e.g., hard copies newspapers, magazines, etc.) to electronic media (e.g., soft copies of such newspapers and magazines, bulletin boards, websites, etc.) that can be processed by computers. Currently, publicly available electronic news sources (e.g., on-line newspapers, internet websites, public bulletin boards, electronic news groups, etc.) account for millions of new or edited electronic pages of information daily. Early significant market shifts can be detected by analyzing these publicly available documents in order to identify trends that provide indications of market shifts, before such trends become well known.

Typically, such an analysis is accomplished by inputting to the computer the mass of new or edited information that is entered into the electronic news sources daily and applying statistical techniques to identify “interesting” patterns within those news sources. Applied as general statistical patterns, standard statistical techniques (e.g., multivariate regression) test potentially hundreds of possible relationships found within the news sources. When these techniques are tuned to spot trends, which might indicate a shift in a market condition, early in their life cycle, this approach can yield a large number of unimportant trends and other unimportant information, which may be characterized as noise. Consequently, the number of issues that are identified and must be reviewed manually is overwhelming, while the most interesting new developments, which represent a very small fraction of the total information retrieved, may be buried with other trends. Thus, the task of analyzing millions of new or edited electronic pages daily is daunting, time consuming, costly, and inefficient.

Therefore, there is a need in the art for a system and method of efficiently and rapidly examining high volume text streams to retrieve data that indicates changes in conditions. There is also a need for an associated system and method for evaluating data retrieved from such high volume text streams.

### SUMMARY

In view of the foregoing, disclosed herein are embodiments of a method of mining data from a high-volume text stream and an associated method for evaluating mined data to discover a change in a condition.

The text mining technique disclosed incorporates the use of predetermined scenarios that characterize a specific change in a condition (e.g., a change in an event, activity, association, market preference, financial status of a competitor, etc.) as well as identified variables that are relevant to those predetermined scenarios. The identified variables are input as mining parameters into a data mining tool. Retrieved data is analyzed statistically and the results of the analysis are evaluated to identify trends and/or patterns suggestive of the change or changes characterized by the predetermined scenarios. Evaluation of the results may include an evaluation to determine statistical significance and/or a visual evaluation. The results according to this mining technique (or any other suitable mining technique) can be evaluated according to the data evaluation technique that is also disclosed herein. The data evaluation technique visually displays results of a statistical analysis as well as additional information in order to allow a user to visually identify data that should be filtered, to identify trends and/or patterns in the data, to assess the identified trends and/or patterns and to prioritize the identified trends and/or patterns, based on the assessment. Once the trends and/or patterns are assessed and prioritized, a user can develop appropriate action plans and prioritize those action plans. Also, disclosed is an embodiment of a system suitable for implementing such methods that is configured to receive user-inputs and, based on the user inputs, mine, store, filter and analyze data as well as display the results of the analyzed data.

More particularly, an embodiment of a method of mining data from a high-volume text stream in order to discover changes in conditions (e.g., changes in events, activities, associations, market preferences, financial status of a competitor, etc.) is disclosed. This data mining technique comprises identifying scenarios that characterize such changes (e.g., characterize one or more changes in conditions). Once the scenarios are determined, templates for each scenario are defined. Each template includes key variables which are relevant to a given scenario. For example, the variables can comprise, but are not limited to, subjects, topics (e.g., persons, places, things, events, etc.) associated with each of the subjects, sentiments related to each subject or topic, geographic locations associated with each of the subjects, source categories, author, and/or date ranges. These variables are input by a user into the system and, in particular, into a data mining tool.

The data mining tool applies a mining algorithm to a high-volume text stream and, using the predetermined variables of the templates as the mining parameters, retrieves occurrences of data that meet the criteria of the mining parameters (i.e., data that is potentially suggestive of a change or changes characterized by one or more of the scenarios).

A statistical analysis can be performed on the retrieved data. The statistical analysis to be performed can be user-selected and modified, on demand. The results of the statistical analysis can be evaluated to identify trends and/or patterns that are suggestive of the change or changes characterized by the predetermined scenarios. Specifically, the results of the statistical analysis can be evaluated for statistical significance within a predetermined threshold and/or visually evaluated in order to identify such trends and/or patterns.

To visually evaluate the results of the statistical analysis, this method of the invention may employ the data evaluation method embodiment described below or any other suitable data evaluation method.

An embodiment of a specific method that may be used to evaluate data mined from a high volume text stream in order to discover changes in conditions (e.g., changes in events, activities, associations, market preferences, financial status of a competitor, etc.) is also disclosed. In this method embodiment, data can be mined according to the above-described technique or can be mined according to any other suitable data mining technique.

Once mined, a statistical analysis of retrieved data is performed and information that is related to the retrieved data is displayed. Specifically, the results of the statistical analysis are displayed in at least one visual format (e.g., in one or more graphs, tables with numerical values and/or text, charts, maps, diagrams, tables, tabulations, etc.). The type and number of formats, as well as the dimensions (e.g., subjects, topics associated with each of the subjects, geographic locations associated with each of the subjects, source categories, date ranges, etc.) can be user-selected and modified, on demand. Other displayed information can include, for example, portions of documents containing data relevant to the displayed results (e.g., relevant to a particular graph or chart), a list of documents containing data relevant to the displayed results, or full documents containing data relevant to the displayed results.

By visually evaluating the displayed information, including the displayed results (e.g., tables, graphs, charts, etc.) and the displayed documents or portions thereof, a user can identify trends and/or patterns in the data that are suggestive of a change or changes (e.g., changes that are characterized by the predetermined scenarios, discussed above). Additionally, while visually evaluating the displayed information, a user can also make data filter selections in order to discard duplicate, near-duplicate, known and uninteresting data. That is, the retrieved data can be filtered so that data contained in a duplicate document, data contained in a near-duplicate document, data meeting specified criteria (e.g., data related to a given subject or topic), previously known data and uninteresting data can be discarded. Filtered data (i.e., the remaining data) can be re-analyzed and re-displayed in the same manner, as described above, in the absence of noise, thereby allowing a user to more accurately identify such trends and/or patterns.

The results of the statistical analysis can also be evaluated for statistical significance within a predetermined threshold in order to further assist a user in identifying such trends and/or patterns.

The trends and/or patterns that are identified can then be assessed. Multiple different types of assessments can be incorporated into the overall assessment of the trends and/or patterns suggested by the data. For example, determinations can be made regarding the significance of the trends/patterns or the type of trends/patterns. Assessments can also be made to determined the likelihood that the change will occur, the potential impacts of the change (e.g., including impacts on one organization as compared to impacts on competitors) and a time frame of the change. Additional assessments can be made to verify the veracity, the validity and the timeliness of the data upon which the trends and patterns are based.

Once the overall assessment of the trends and/or patterns is complete, they can be prioritized. Based on the assessment and the priority assigned to the various trends and/or patterns, responsive action plans can be developed as well as prioritized.

Also, disclosed herein is an embodiment of an exemplary system for mining and analyzing and evaluating data from a high volume text stream in order to discover and evaluate changes in conditions (e.g., changes in events, activities, associations, market preferences, financial status of a competitor, etc.). The system can comprise a user-interface, a data mining tool, an analyzer, a display screen, a data base, data filters and a controller.

The controller can be configured so that it is in communication with and can provide communication between each of the other listed features of the invention and can further be adapted to provide overall control of the system based on user input (e.g., via the user-interface).

The user-interface can be adapted to allow a user to input variables that are relevant to at least one user-identified scenario that characterizes the change (e.g., subjects, topics associated with each of the subjects, geographic locations associated with each of the subjects, source categories, date ranges, etc.). The user-interface is further adapted to allow a user to input additional instructions to be implemented within the system via the controller (e.g., execution instructions for the data mining algorithm, selections for the statistical analysis to be applied by the analyzer, display selections, data filter selections, etc.).

The data mining tool can be configured to apply a data mining algorithm to a text stream in order to retrieve data. The mining algorithm can comprise a set of unstructured text analytics mining algorithms. The parameters for the data mining algorithm can comprise variables that are input by a user and that are relevant to one or more user-identified scenarios that characterize a change or changes. The data retrieved by the data mining tool can be stored in the system data base.

The analyzer can be adapted to perform a statistical analysis of the stored data that is retrieved by the data mining tool. Additionally, the analyzer can be adapted to identify the results of the statistical analysis that are statistically significant within a predetermined threshold.

The processor can be adapted to convert results of the analysis into one or more visual formats (e.g., one or more graphs, charts, tables with numerical values and/or text, maps, diagram, tabulations, etc.). The number and types of these visual formats as well as the dimensions thereof can be selected by the user (e.g., via the user interface) and modified, on demand. The user-selected dimensions can comprise one or more of the scenario variables, including, subjects, topics associated with each of the subjects, geographic locations associated with each of the subjects, source categories, date ranges, etc.

The display can adapted to display the results of the analysis so that a user can visually identify trends and/or patterns therein that are suggestive of the change. Specifically, the display can be adapted to allow multiple visual formats (e.g., one or more different graphs, charts, tables, maps, diagram, tabulations, etc.) to be displayed simultaneously. The display can further be adapted to simultaneously display additional information, such as portions of documents containing data that is relevant to the displayed results, a list of documents containing the data that is relevant to the displayed results or the full text of the documents containing data that is relevant to the displayed results. As mentioned above, the display information can be selected and modified by a user, on demand, to optimize the usefulness of the visual evaluation tool.

The data filters can be adapted to discard user-specified data. Specifically, following a visual evaluation of displayed information, including the displayed results of the statistical analysis (e.g., graphs, charts, etc.) and the displayed documents or portions thereof from which the data represented in the displayed results was retrieved, a user may determine that certain retrieved data should be filtered-out (i.e., discarded). For example, a user may request filtering out of specific data that is contained in a duplicate document, contained in a near-duplicate document, matches certain criteria (e.g., related to a specific subject, topic, date or other value), was previously known data or is considered by the user to be uninteresting.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating an embodiment of a method of the invention;

FIG. 2 depicts an exemplary relational database schema;

FIG. 3 depicts an exemplary display screen; including analysis results displayed in a visual format and portions of documents containing data upon which the visual displayed results are based;

FIG. 4 is a flow diagram illustrating an embodiment of another method of the invention;

FIGS. 5-7 are exemplary graphs which may be displayed and visually evaluated according to the method of FIG. 4;

FIG. 8 comprises a schematic diagram illustrating an exemplary system suitable for implementing the methods of FIGS. 1 and 4; and

FIG. 9 is a schematic diagram of an exemplary hardware structure that may be used to implement the methods of FIGS. 1 and 4.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

Most traditional business intelligence operates by reading large bodies of information and applying statistical techniques to identify “interesting” patterns and/or trends within that information. Applied as general statistical patterns, techniques, such as multivariate regression, are used to test possible relationships in the data. When tuned to spot events early in their life cycle, this approach can yield a large number of unimportant trends and/or patterns and other information that might be characterized as noise. Far too many issues to review manually turn up and the most interesting new developments may be buried because the information of greatest interest represents only a very tiny fraction of the total information available. Thus, as mentioned above, there is need in the art for a system and method of efficiently and rapidly examining high-volume text streams to retrieve data that indicates changes in conditions (e.g., changes in events, activities, associations, affiliations, financial status of competitors, etc.). There is also a need for an associated system and method for analyzing data retrieved from such high volume text streams.

In order to have computer systems read massive amounts of text and still efficiently and accurately identify useful changes in conditions several challenges must be over come. These challenges include, novelty, importance, actionability, transient issues, undetected trends/issues, timeliness, etc., and are explained in detail below.

Regarding novelty, many changes and new events in the environment are important, but not novel or unexpected. For example, the yearly change of seasons has significant effects, but it is not novel or unexpected. An automated system for discovering changes in the external environment does not know this a priori, so an object of the techniques disclosed herein is to intelligently differentiate novel information from common knowledge. The problem is to identify useful previously unknown information.

Regarding importance, not all novel changes in the environment are also important for any given company. For example, the development of electronic file sharing of music has been significant for the music industry, but has had little visible impact on the petroleum industry. Therefore, an object of the techniques disclosed herein is to consider, for each industry or category, only the relevant changes that are most critical to track.

Regarding actionability, often a change is important, but early detection by a few months will not lead to significantly different actions. For example, the development of a new algorithm for optimizing truck deliveries might have significant long-term impacts for the retail industry, but the immediate management response for a retailer may not exist. Thus, spotting this change is not advantageous.

Regarding transient issues, there is significant difficulty in identifying so many possible issues and patterns that an organization can not evaluate all of them. Thus, instead of resolving information overload, systems that identify too many trends simply add to it or worse mislead a company to spend resources on issues that appear important, but are actually transient and irrelevant. With 1.5 trillion new pages of information generated a month, there are almost an unlimited number of possible new patterns or trends. Therefore, another object of the mining technique disclosed herein is to efficiently sort through possible items of interest and focus on those most likely to persist and require action.

Regarding undetected trends/issues, equally problematic are cases in which systems are too finely tuned to recognize patterns in their earliest stages so that important trends are not identified early. As stated earlier, an object of the techniques disclosed herein is to identify meaningful, actionable trends early in their life cycle, without either identifying too many “non-issues” or missing real issues.

Regarding timeliness and currency, in order for a pattern to be identified from a collection of documents, one or more time stamps are associated with each relevant document. These time stamps indicate the timeframe which the document was written by the author, posted to a public online medium, or made available to the public such as the street date. At a minimum, the time stamp should include the date (year, month and date); in a few instances, the time of day may also be relevant, especially for those events that happen over a short period. Since oftentimes informally written content does not have time and date stamps, another object of the techniques disclosed herein is to assign a time dimension if none exists.

Taking into consideration the challenges described above, disclosed herein are embodiments of a method of mining data from a high-volume text stream, a method of evaluating that data and a system for implementing these methods in order to efficiently and accurately discover significant changes in the conditions early so that a firm or organization can take advantage of emerging beneficial changes (e.g., emerging market opportunities) and proactively address emerging disadvantageous changes.

The text mining technique disclosed is used to identify data and evidence from high-volume text streams that would suggest specific changes in conditions (e.g., changes in events, activities, associations, financial status of competitors, etc.). The approach used reverses the usual approach of starting with raw data and moving toward suggested events. Specifically, this text mining technique incorporates the use of predetermined scenarios that characterize one or more specific changes as well as identified variables that are relevant to those predetermined scenarios. The identified variables are input as mining parameters into a data mining tool. Retrieved data is analyzed statistically and the results of the analysis are evaluated for statistical significance and/or evaluated visually in order to rapidly and efficiently discover relevant changes. Data mined according to this mining technique (or any other suitable mining technique) can be evaluated according to the data evaluation technique that is also disclosed herein. The data evaluation technique visually displays results of a statistical analysis as well as additional information in order to allow a user, in conjunction with his knowledge of the industry and organization, to identify data that should be filtered, to identify trends and patterns in visually displayed data, to assess the trends and patterns and to prioritize the trends and patterns, based on the assessment. Once the trends and patterns are assessed and prioritized, a user can develop an appropriate action plan. Also, disclosed is an embodiment of a system suitable for implementing such methods.

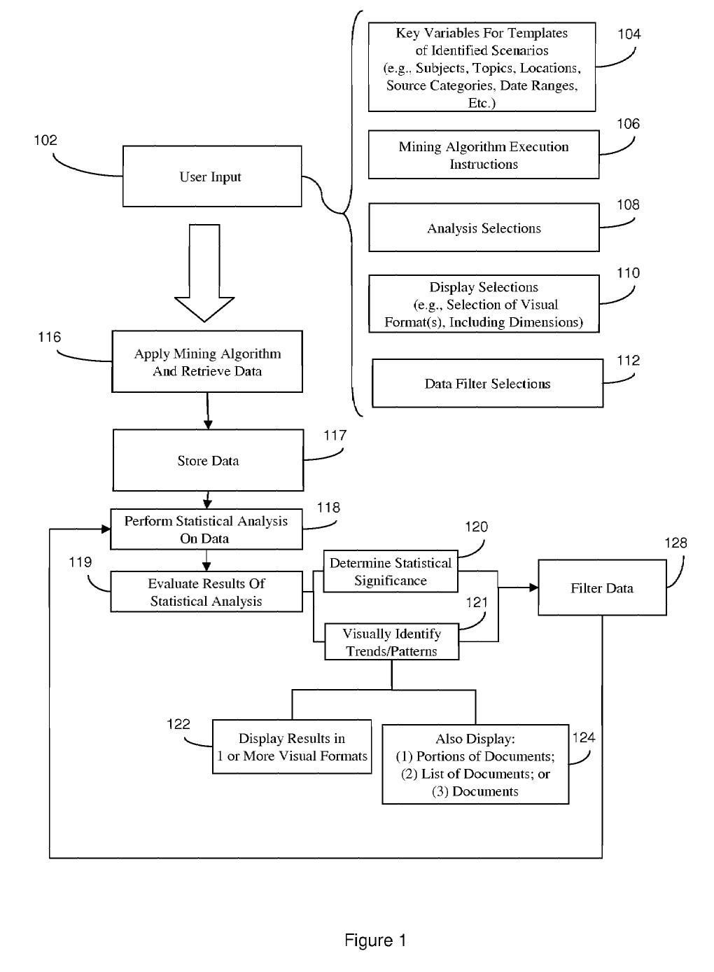

More particularly, referring to FIG. 1, an embodiment of a method of mining data from a high-volume text stream in order to discover changes in conditions (e.g., changes in events, activities, associations, financial status of competitors, etc.) is disclosed. The method of the invention comprises identifying scenarios that characterize specific changes (e.g., six to ten relevant scenarios that characterize one or more specific changes). These scenarios should describe changes that have a high likelihood of being novel, discrete, relevant, important, actionable and accurately identifiable. The bounding of the problem space in this manner both hugely reduces the occurrence of false issues and allows a much more sensitive detection of the types of scenarios that are more critical early in their appearance.

Once the scenarios are determined, templates for each scenario are defined. Each template includes key variables which are relevant to a given scenario (104). The template is a data structure that is filled in by a combination of manual entry and automatic methods applied to a large, continuous text stream (such as a web crawl, RSS feed, or document stream). The objective of this step is to define variables comprehensively and specifically so that high-precision identification of occurrences that meet the scenario criteria can be found. For example, the variables can comprise at least one of subjects, topics (e.g., person, place, thing, event, etc.) associated with each of the subjects, sentiment related to each subject or topic, geographic locations associated with each of the subjects, source categories, authors, and date ranges. These variables are input by a user (102) into (i.e., received by) the system and, in particular, a data mining tool within the system.

More specifically, a template is a set of variables that are defined which allow the scenario to be tracked and that can be extracted with accuracy by automated text mining techniques. As mentioned above, the key variables are comprehensive and specific and can include a set of subjects, topics of interest, geographic location, websites or sources that contain the mentions and date.

Subjects can include the specific subjects that are relevant to a given scenario. Examples of subjects that can be defined include company names and subsidiaries, company names in the same industry (oftentimes one company's issues have ripple effects through the entire industry), executive and board member names, special interest group names, nick names of companies, and names of campaigns or products. Subjects may also be, for example, product names, film or album titles, or any primary set of object of interest. Synonyms of subjects can also be included and names can be disambiguated names as appropriate.

Topics can include the interesting associations for each subject. Examples of topics that can be defined for a company can include product names, new technologies or practices that may be sensitive or debated publicly, manufacturing facility names, past environmental issues and associated campaign names. Topics can also, for example, include people associated with a company or product, or a key advertising phrase, or any distinguished topic of interest relevant to the set of subjects.

Geographic locations can include the city, county/province/state, country or other location or locations that are relevant for each subject. Examples of locations that can be defined for a company can include the locations of the corporate headquarters, manufacturing facilities or operations. Such locations can be defined narrowly or broadly.

Source (i.e., sources of the electronic text documents) categories can include the groups of digital sources that may be reporting on an event or communicating the important change. For example, one source category may be defined as “local/regional environmental special interest groups” and include websites for specific groups. Another source category may be “national media” and include digital data sources, such as, websites for on-line newspapers or other news media. Another source category may be “personal publications” which include personal blog sites, bulletin boards, etc. Other source categories may indicate if a document is from a pre-defined list of newspapers, non-governmental organizations (NGO) websites, influential blog sites, electronic newsletters, etc. Additionally, a combined source category may reflect that the a document has multiple sources.

Dates can include dates which are captured from each document for data analysis (e.g., the date the document was created, the date the document was modified, dates contained within the text of the document, etc.). These dates can be used to specify the date range for selecting the documents in the analysis. For example, a date range of three to four weeks from the present time may be desirable for getting emerging issues or a date range of more than three months can be selected for trending analysis. Older documents that mention then-controversial issues may not be relevant for current analysis.

Other variables can also be included in the template, e.g., readership or circulation of the sources, demographic information of sources, etc.

In response to user supplied execution instructions (106), the data mining tool applies a mining algorithm to a high-volume text stream and, using the input variables of the templates as the mining parameters, retrieves data that is suggestive of a change or changes indicated by the identified scenarios (116). Specifically, mining algorithms are applied to automatically identify references to the variables (e.g., subjects, topics, etc.) in the text stream. All the variations of the variables (e.g., subject names, topic terms and phrases, etc.) can also be identified in the documents. Other characteristics, such as geographic information and sentiment evaluation can be computed for each identified subject reference. This computation is done around the vicinity of the spotted entity which is within a sentence, paragraph or a given number of words or tokens before and after the subject spot. Additional topics can also optionally be obtained by clustering the words that are interesting and occur frequently around an entity or a number of entities. Consequently, by identifying instances of the key variables and related statistics in the input stream, the mining algorithm can accurately and efficiently identify the evidence of each scenario.

An exemplary data mining algorithm suitable for implementing this technique can comprise a set of unstructured text analytics mining algorithms (e.g., See U.S. patent application Ser. No. 11/160,943, filed on Jul. 15, 2005 and incorporated herein by reference, which discloses an exemplary mining algorithm suitable for use herein). The high-volume text stream from which the data is mined can comprise one or more text-based electronic documents (e.g., an unstructured text document (UTD)). The documents can be selected, for example, from the world wide web (WWW), from a wide area network (WAN), from a local area network, etc and may be preprocessed, for example, by a preprocessor, in order to provide “noise free” text to the mining algorithm.

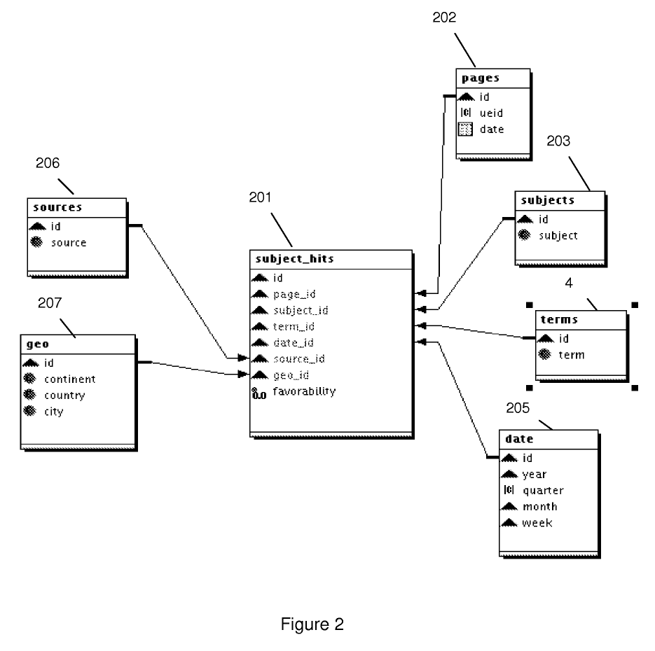

Once the data is retrieved by the mining algorithm at process 116, it may be stored, for example, in a common data structure such as a data base (117). More specifically, the retrieved data can be inserted in appropriate fields in the templates. An exemplary structure for storing the templates and the data retrieved from the mining operations is a relational database. FIG. 2 illustrates an exemplary relational database schema 200 in which a fact table 201 or set of fact tables defines the attributes of the items being analyzed. This analysis may be done at a web page level or some other granularity. The fact tables(s) 201 can refer to additional tables 202-207 which describe the categories or dimensions that are the parameters of the analysis, that is, the entities, topics, dates, etc. The fact tables(s) may directly reference the dimension tables 202-207 if there is a one-to-one correspondence between the item and the dimension, as illustrated, or indirectly via membership tables, which reference both the fact table entry and the dimension entry, allowing for many-to-one or many-to-many relationships between the data.

A statistical analysis can then be performed on the retrieved data (118). The statistical analysis can be user-selected and modified, on demand (108). The results of the statistical analysis can be evaluated to identify trends and/or patterns that are suggestive of a change or changes characterized by the predetermined scenarios (119). Specifically, the results of the statistical analysis can be evaluated (e.g., by a processor) for statistical significance within a predetermined threshold and/or evaluated visually in order to identify such trends and/or patterns (120-121). Known techniques may be used to determine whether the results are statistically significant and/or to visually evaluate the results.

Additionally, a novel technique for visually evaluating the results of the analysis at process 121 is also disclosed. This technique can comprise displaying the results in one or more visual formats (e.g., graphs, tables with numerical values and/or text, charts, maps, tabulations, diagrams, etc.) (122). The number and types of visual formats to be displayed as well as the dimensions thereof (e.g., subjects, topics associated with each of the subjects, geographic locations associated with each of the subjects, source categories, date ranges, etc.) can also be user-selected and modified, on demand (110). These graphs, tables, etc. can be visually evaluated by the user in order to identify trends and/or patterns in the data suggestive of important, novel, actionable, timely, etc., changes in conditions.

Sample visual formats that would facilitate discovery of potentially significant market changes can include, for example: (a) the “number of mentions,” where the y-axis is the number of mentions and the x-axis are topics for each subject (e.g., comparing the number of mentions of one brand of automobile and safety with the mentions of another brand of automobile and safety); (b) “term associations,” where the y-axis is the number of mentions and the x-axis are the emerging topics associated with companies or products over time (e.g., increase in mentions of “genetically modified foods,” “aquaculture,” etc., over time; (c) “term associations,” where the y-axis is the number of mentions and the x-axis are the most frequently mentioned topics by source category (e.g., “downloading music” in regional newspapers vs. “downloading music” in personal web logs), etc.

In addition to visually displaying the results of the analysis (at process 122), other information may also be simultaneously displayed for evaluation by the user (124). For example, on demand, a user may choose to display a list of documents containing data relevant to the displayed results (e.g., relevant to a particular graph or chart), portions (i.e., a “snippet” or text fragment) of documents containing data relevant to the displayed results, or full documents containing data relevant to the displayed results. Thus, a user can drill down from a list of documents through a list of snippets to the actual document from which the snippet comes, thereby, allowing the item to be viewed in its original context. This technique allows the raw data associated with a particular visualization to be displayed in order to illustrate the rationale for including data from a particular document in the evaluation.

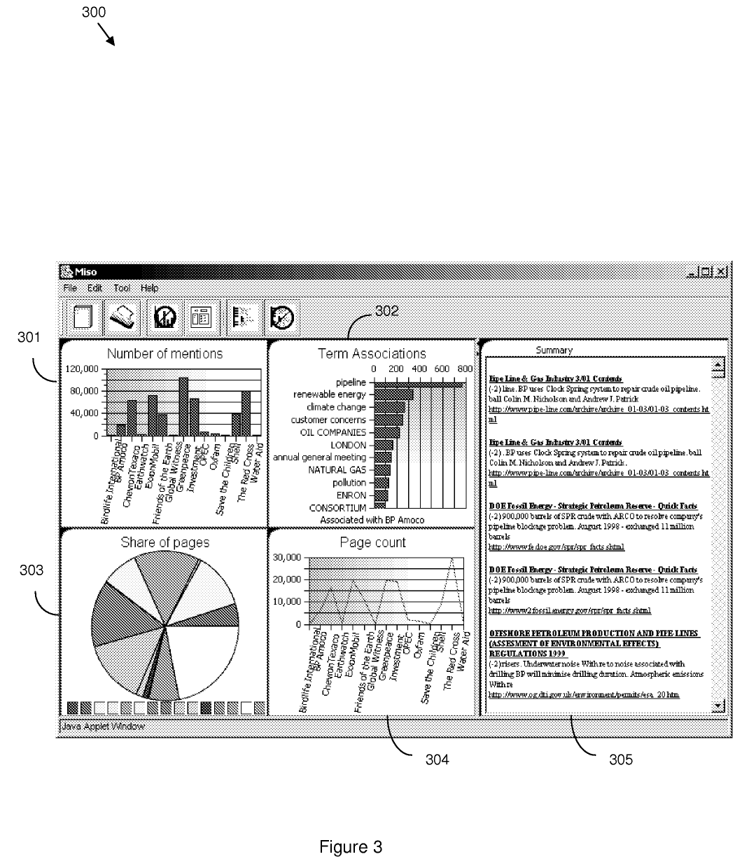

Thus, for example, referring to FIG. 3, an exemplary graphical user interface screen display 300 can comprise display results in multiple visual formats 301-304 with various dimensions (e.g., graphs/charts depicting summary counts of items in a particular dimension, counts of items in one dimension that relate to a particular item, references in a dimension displayed as percent share of total references, change in references over time, etc.). Additionally, the screen 300 can comprise portions 305 of those document from which the data represented in the graphs/charts 301-304 was obtained (i.e., selected snippets 305 of documents for drill down).

By evaluating the displayed information, including both the displayed results (e.g., graphs, charts, etc.) at process 122 and the displayed documents or portions thereof at process 124, a user can also make data filter selections in order to discard duplicate, near-duplicate, known and uninteresting data (128). That is, the retrieved data can be filtered so that data contained in a duplicate document, data contained in a near-duplicate document, previously known data, data meeting a specified criteria (e.g., related to a given subject or topic) and uninteresting data can be discarded. Filtered data can be dynamically re-analyzed and re-displayed in the same manner, as described above at process 117-124, thereby allowing a user to evaluate more accurate results (i.e., results that include less noise) in order identify significant trends and/or patterns in the data that are suggestive of important, novel, actionable, timely, etc., changes characterized by the predetermined scenarios.

More specifically, this exemplary visualization technique works by accessing fields from the templates based on three factors, the user's selection and filtering input, the template design and the type of comparison desired. Consequently, because this visualization technique supports comparisons of values across multiple dimensions (e.g., showing how subjects differ by source category, etc.) and because a user can see how a subject (or subjects) is being discussed in certain sources or in certain timeframes, the “noise” of having all the data treated as a single conglomeration is eliminated and it is easier for a user to discover significant events or trends.

It is further anticipated that the data evaluation technique, disclosed above, for evaluating data mined at process 116 of FIG. 1 can also be used to evaluate data retrieved by any other suitable data mining tool.

More particularly, as mentioned above, the evaluation process 119, includes displaying information related to the mined data (see processes 122-124). The displayed information includes the results of a statistical analysis of the mined data in at least one visual format (e.g., in one or more graphs, tables with numerical values and/or text, charts, maps, diagrams, tables, tabulations, etc.) (122). The type and number of formats, as well as the dimensions (e.g., subjects, topics associated with each of the subjects, sentiments associated with subjects or topics, geographic locations associated with each of the subjects, source categories, authors, date ranges, etc.) can be user-selected and modified, on demand (110). These graphs, tables, etc. can be created, for example, using external tools such as spreadsheets and not necessarily the system tool of the invention. That is, the system tool functions can be designed to complement the capabilities of known tools graphing tools. The displayed information can also include a list of documents containing data relevant to the displayed results, portions of documents containing data relevant to the displayed results or documents containing data relevant to the displayed results (124).

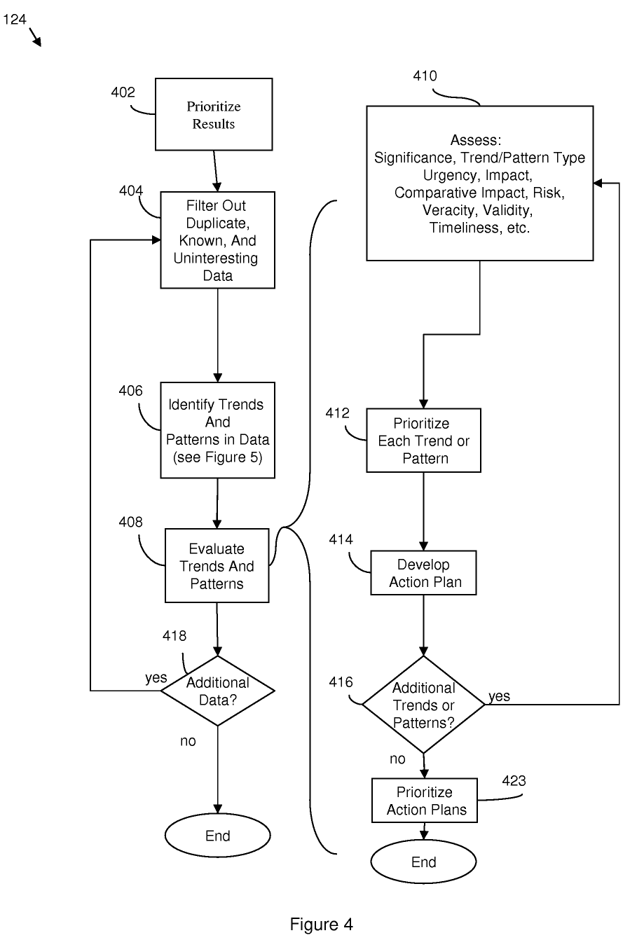

Referring to FIG. 4, a user can visually evaluate the displayed information, including the displayed results (e.g., graphs, charts, etc.) and the displayed documents or portions thereof, in order to prioritize the data that is to be evaluated further (e.g., by subject or topic) (402) and make data filter selections (404).

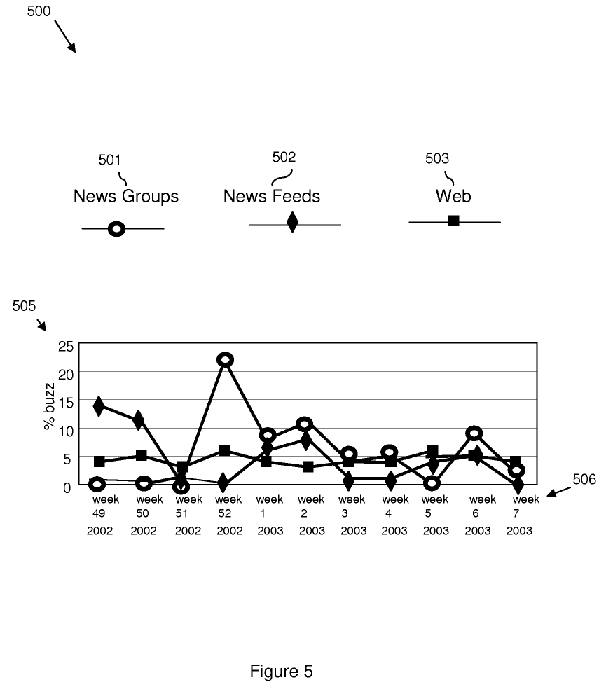

For example, at process 402 an analyst may take advantage of the filtering capabilities of the visualization tool to identify the scenarios or template definitions that yielded results that beg further investigation. Referring to the graph 500 of FIG. 5, this chart could show the trend of a company and an associated term by source categories. The y-axis 505 illustrates the relative number of mentions and the x-axis 506 shows time for three different source categories 501-503. News groups 501 and web postings 503 may be indicative of public/consumer opinion and news feeds 502 may be indicative of media perspective. Thus, a user may decide to investigate further the upward spike in the number of mentions in news groups 501 in week 52, and then the upward spikes in the number of mentions in subsequent news feeds 502 because there might have been some ripple effects from one source 501 to another 502 (e.g., journalists may have picked up a topic from public reaction). With this approach, a user could also identify the templates or the subject and topic combinations to investigate further (this is bounded by the amount of time the user has allowed for such an analysis). As mentioned above, the evaluation of the results of the statistical analysis does not have to be solely visual. Visual assessment can be accompanied by an evaluation to determine statistical significance. That is, measurement criteria can be established to determine whether a spike or drop in data values is significant statistically or indicative of a trend and worth further examination (for example, one criterion can be “any percentage change over 10% in a two-week period is significant”).

At process 404, in order to filter the data, the user can visually identify data, such as data contained in a duplicate document, data contained in a near-duplicate document, data matching specific criteria (e.g., data related to certain subjects, topics, geographies, sources, date ranges, etc.), previously known data or uninteresting data, and filter-out (i.e., discard) the identified data. Specifically, some of the evidence returned by the data mining algorithm may not be unique, e.g., one news agency story by one writer may be carried by several on-line newspapers. For some analyses, it may make sense to discard duplicate or near-duplicate documents if the breadth or coverage of a particular article is not of primary interest. Additionally, known or uninteresting evidence, based on a user's knowledge of the industry and/or knowledge a particular company, can also be discarded. For example, if two documents are returned that match the template definition and of those documents one is a web page containing a simple table of contents of an edition of a newspaper and another page contains a full-length article that is listed on the table of contents, the user can elect to discard (i.e., filter-out) data contained in the table of contents page. The remaining data (i.e., filtered data) can then be re-analyzed and re-displayed in the same manner, as described above, thereby allowing a user to evaluate more accurate results (i.e., results that include less noise) in order identify significant trends and/or patterns in the data that are suggestive of important, novel, actionable, timely, etc., changes at process 406, discussed below.

Following prioritizing and filtering of the data at processes 402-404, potentially significant patterns and/or trends can be identified by visually examining the displayed information (406). That is, for each evidence collection returned for a template definition, a user can identify trends and/or patterns, based on the source of the claim, the number of mentions of the claim, the authoritativeness of the claimant, etc. For example, if the scenario variables define a particular brand of soda as a subject, “adolescents” as the topic, personal web sites and blogs as sources for postings in the last three months, then there may be a handful of patterns in the evidence that can be grouped together, such as “reaction to that brand of soda in vending machines in public schools,” “childhood obesity,” and “alternatives to drinking that brand of soda.”

The identified trends and/or patterns can then be assessed (408). Multiple different assessments (410) can be incorporated into the overall assessment of the trends and/or patterns. For example, determinations can be made regarding the significance of the trends/patterns (e.g., Are the trends and patterns statistically significant within a predetermined threshold?) or the type of trends/patterns (e.g., is the change indicated by the trend/pattern beneficial or adverse?). Assessments can also be made to determined the likelihood that the change will occur, the potential impacts of the change (e.g., including impacts on one organization as compared to impacts on competitors) and a time frame of the change. Additional assessments can be made to verify the veracity (e.g., How reliable are the specific sources and/or the source categories for the data upon which the trends and patterns are based?), the validity (Are the trends and patterns contradictory?) and the timeliness (i.e., currency) of the data upon which the trends and patterns are based.

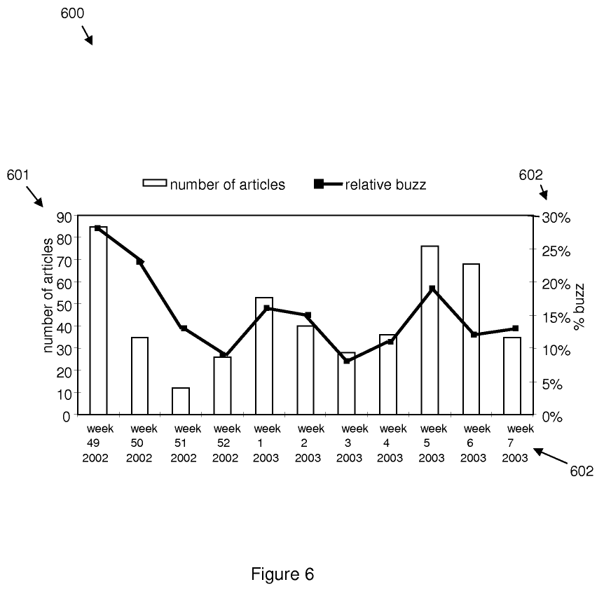

More specifically, various aspects of each trend and/or pattern identified can be assessed. One aspect could be the significance of the trend or pattern. That is, additional statistical analyses can be performed to determine if a change suggested by a trend or pattern is statistically significant within a given threshold. For example, the graph 600 of FIG. 6 illustrates trending for a given company and associated term, the number of articles for each theme and the percent of buzz (i.e., (the number of articles for a given subject associated term)/(the number of articles for all associated terms for a given subject)) for each week. If there is a 50% increase in the number of articles 601 over a given period of time 602 (e.g., from the previous week to the current week) with a typical week resulting in 30 articles for a scenario, then a user could determine if this change is statistically significant, or if it is part of the normal fluctuation in volume for that scenario. The variance would depend on the topic per subject, and statistically significant changes would be evident after monitoring the topic per subject for several time periods. Data that is not considered statistically significant could be eliminated from further consideration as noisy evidence and/or data that is considered statistically significant could be marked as warranting further investigation (e.g., investigation into what is being said, who is saying it, etc.). Additionally, a more sensitive threshold could be established for events or discussions around a potentially disastrous public relations crisis. Also, measurement criteria should consider how an organization is discussed in these public sources with respect to its competition (e.g., a criticism may not warrant immediate action if competitors in the same market are also named and the organization is not singularly accused).

Another aspect could be the type of trends or patterns identified. That is, a determination can be made by a user as to whether or not the change suggested by the retrieved data is beneficial or adverse (i.e., represents an opportunity or a threat to a company, firm, etc.). For example, potentially disastrous crisis, if managed well and promptly by the company's executives, could end up reflecting positively on the company. Additionally, organizations will often handle imminent threats differently (perhaps with more immediacy and with more executive involvement) than opportunities.

The urgency of the identified trends and patterns could also be assessed. That is, by considering the operational mode of an organization, the urgency of a response to the change indicated by the trend or pattern can be assessed. For example, if the organization is undertaking a critical project in which the milestones call for a specific operation to take place within a certain timeframe but activists are planning to thwart the employees from completing that task, the issue may need to be managed swiftly as an exception. In contrast, if an organization is planning to launch a new product in six to nine months and there was negative public reaction towards a similar competitor's product launched three months prior, the organization would incorporate the findings using existing business processes.

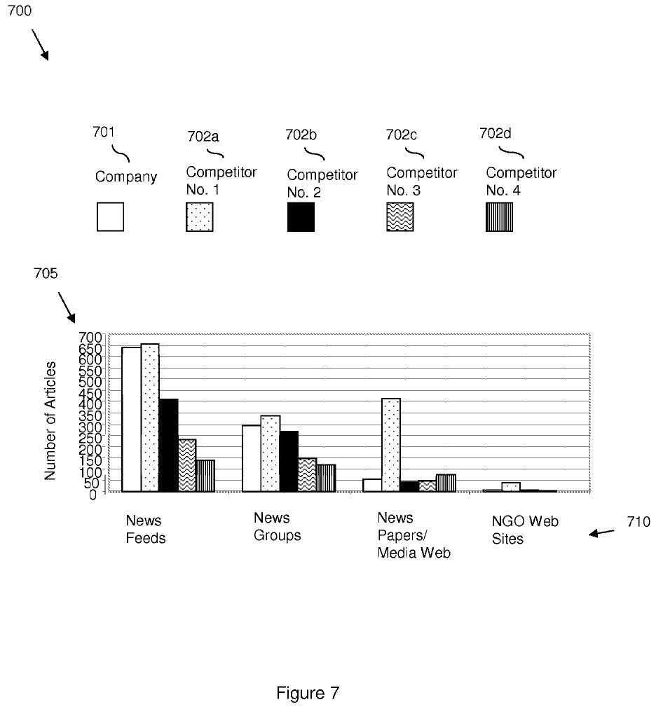

The potential impact on a company, organization, etc. of a change indicated by a trend or pattern can be assessed, as well as the relative impact to the competitors of that company. That is, the impact of each identified trend or pattern can be assessed by considering worst-case and best-case situations. Consideration would be given to the audience of the document, the short-term and long-term actions for the range of possibilities, etc. Furthermore, the relative impact to competitors (i.e., the reach of the change) may also affect a company's response to the change. For example, graph 700 of FIG. 7 illustrates both the number of articles 705 for a company 701 and the number of articles for each of its competitors 702a-b by source category 710 during a given time period. The comparison may also be interesting if the frequency of mentions do not correspond to obvious factors, such as, size of a company, business location, etc.

The risk associated with the change can also be assessed. That is, what is the likelihood of the risk, how widespread will the evidence be known, is the risk acceptable, etc.

Other aspects of the identified trend and pattern that should be assessed include the authority (i.e., veracity or feasibility), validity and timeliness of the data upon which the trend/pattern is based. Specifically, the veracity or feasibility of each trend or pattern should be verified, using historical or other references. For example, an environmental organization may post damaging, critical remarks about the company's handling of the spill on their web site, but a user may recognize that the particular organization often has extreme views that are not well regarded or supported by others, and that they will not have much influence. Additionally, the categories of sources can be further broken into more granularly considering the readers and reach of the publication; for instance, news feeds can be differentiated by international and national sources, as a company may have different reputations and operations overseas and nationally. Non-governmental organizations may also be differentiated by their membership profile and activities in the spectrum of high activity and pro-activeness to low, broad recognition and opinion-leader vs. serving local interests, etc. Furthermore, each pattern or trend should be compared with the organization's current understanding of the marketplace. For example, does the trend contradict this understanding?, is the pattern an indication of a mismatch of company's messaging and positioning?, etc. Finally, the timeliness or currency of the evidence and the consequences from the results should be considered. For example, one environmental organizations web site might state that they are considering a letter-writing campaign for the next two weeks against all manufacturing plants in the local region. If relevant information is obtained early, corrective action can be less costly, both in terms of publicity and resources.

Once the overall assessment of the trends and/or patterns is complete, the assessments can be used to prioritize the trends and/or patterns (412). Based on the assessment and priority assigned to the various trends and patterns, responsive action plans both short and long-term can be developed (414). For example, short-term actionable business actions that effectively respond to each pattern or trend can be developed. In developing these short-term plans both corporate functions (e.g., strategic functions, executive management, communications, corporate attorneys, etc.) as well as line of business functions (e.g., product groups, marketing messages, etc.) that may need to act should be considered. Additionally, business processes, management processes within the organization, and longer-term actions that need to modified to effectively respond to each pattern or trend can be developed.

The processes, described above, can be repeated for additional trends and/or patterns or additional data (416-422), as necessary, and action plans that are developed at process 414 can be prioritized (423) based on urgency, potential harm, etc.

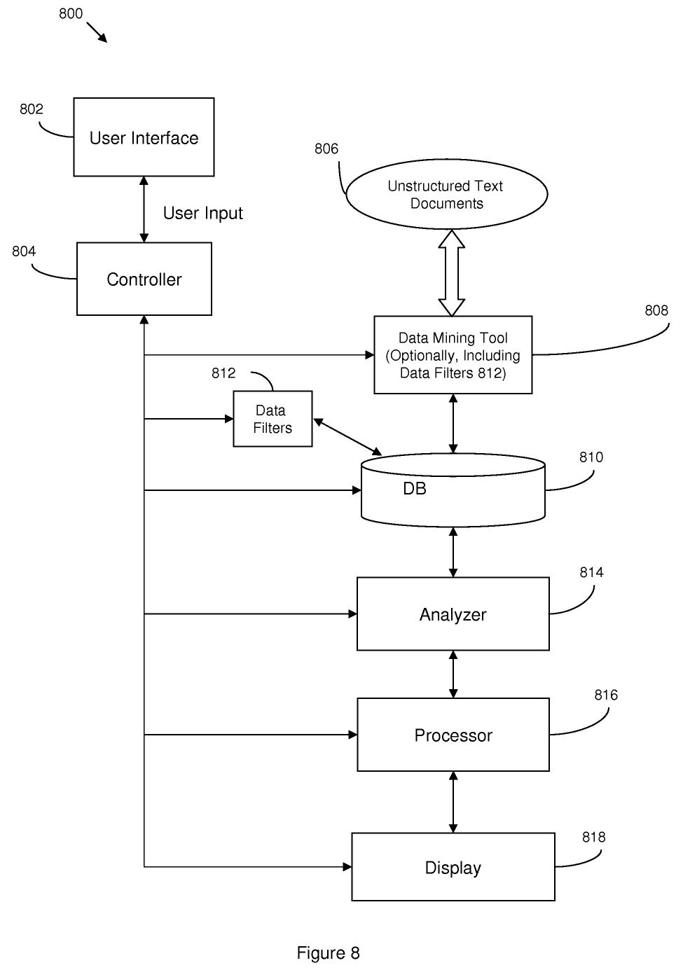

Referring to FIG. 8, also disclosed herein is an embodiment of an exemplary system 800 for mining, analyzing and evaluating data from a text stream in order to discover and assess changes in conditions (e.g., changes in events, activities, associations, affiliations, market preferences, financial status of competitors, etc.). The system 800 can comprise a user-interface 802, a data mining tool 808, an analyzer 814, a display screen 818, a data base 810 (or other suitable storage device), data filters 812 and a controller 804.

The controller 804 can be configured so that it is in communication with and can provide communication between each of the other listed features of the invention and can further be adapted to provide overall control of the system 800 based on user input (e.g., via the user-interface 802).

Specifically, the user-interface 802 can be adapted to allow a user to input variables that are relevant to at least one user-identified scenario that characterizes the change (e.g., subjects, topics (i.e., persons, places, things, events, etc.) associated with each of the subjects, sentiments associated with each topic or subject, geographic locations associated with each of the subjects, source categories, authors, date ranges, etc.). The user-interface 802 is further adapted to allow a user to input additional instructions to be implemented within the system 800 via the controller 804 (e.g., execution instructions for the data mining algorithm, selections for the statistical analysis to be applied by the analyzer, display selections, data filter selections, etc.).

The data mining tool 808 can be configured to apply a data mining algorithm to an input text stream (e.g., unstructured text documents 806) in order to retrieve data. The mining algorithm can comprise a set of unstructured text analytics mining algorithms. The parameters for the data mining algorithm can comprise variables that are input by a user and that are relevant to one or more user-identified scenarios that characterize a change or changes. As mentioned above, an exemplary data mining algorithm can comprise a set of unstructured text analytics mining algorithms (e.g., See U.S. patent application Ser. No. 11/160,943, filed on Jul. 15, 2005 and incorporated herein by reference, which discloses an exemplary mining algorithm suitable for use herein).

The high-volume text stream 806 from which the data is mined can comprise one or more text-based electronic documents (e.g., an unstructured text document (UTD)) and the system 800 can further be configured such that the documents 806 are accessible, for example, via the world wide web (WWW), via a wide area network (WAN), via a local area network, etc. Prior to processing by the data mining tool 808 these electronic documents 806 can, optionally, be preprocessed by a preprocessor in order to provide “noise free” text to the mining algorithm.

Once the data is retrieved by the data mining tool 808, it may be stored, for example, in a common data structure 810 such as a data base. More specifically, the retrieved data can be inserted in appropriate fields in the templates. Referring to FIG. 2, an exemplary structure 200 for storing the templates and the data retrieved from the mining operations is a relational database. In this exemplary relational database schema 200, a fact table 201 or set of fact tables defines the attributes of the items being analyzed. This analysis may be done at a web page level or some other granularity. The fact tables(s) 201 will refer to additional tables 202-207 which describe the categories or dimensions that are the parameters of the analysis, that is, the entities, topics, dates, etc. The fact tables(s) may directly reference the dimension tables if there is a one-to-one correspondence between the item and the dimension, as illustrated, or indirectly via membership tables, which reference both the fact table entry and the dimension entry, allowing for many-to-one or many-to-many relationships between the data.

The analyzer 814 can be adapted to perform a statistical analysis of the stored data. Additionally, the analyzer can be adapted to identify the results of the statistical analysis that are statistically significant within a predetermined threshold. Additionally, the processor 816 can be adapted to convert results of the analysis into one or more visual formats (e.g., one or more graphs, charts, tables with numerical values and/or text, maps, diagram, tabulations, etc.). The number and types of these visual formats as well as the dimensions thereof can be selected by the user (e.g., via the user interface) and modified, on demand. The user-selected dimensions can comprise one or more of the scenario variables, including, subjects, topics associated with each of the subjects, sentiments associated with topics and subjects, geographic locations associated with each of the subjects, source categories, authors, date ranges, etc. It is anticipated that commercially available visualization and graphical analysis software may be used to implement the analyzer 814 and processor 816 features of the system 800.

The display 818 can be adapted to display the results of the analysis so that a user can visually identify trends and patterns therein that are suggestive of the change. Specifically, the display can be adapted to allow multiple visual formats (e.g., one or more different graphs, charts, tables, maps, diagram, tabulations, etc.) to be displayed simultaneously. The display 818 can further be adapted to simultaneously display additional information, such as, a list of documents containing the data that is relevant to the displayed results, portions of documents containing data that is relevant to the displayed results, or the full text of the documents containing data that is relevant to the displayed results. As mentioned above, the display information can be selected and modified by a user, on demand, to optimize the usefulness of the visual evaluation tool.

Thus, for example, referring to FIG. 3, an exemplary graphical user interface screen display 300 can comprise display results in multiple visual formats 301-304 with various dimensions (e.g., graphs/charts depicting summary counts of items in a particular dimension, counts of items in one dimension that relate to a particular item, references in a dimension displayed as percent share of total references, change in references over time, etc.). Additionally, the screen 300 can comprise portions 305 of those document from which the data represented in the graphs/charts 301-304 was obtained. By means of a graphical user interface 802 a user may select and modify the displayed results and/or drill down from a list of documents through snippets of documents to the actual documents, thereby, allowing a data item to be viewed in its original context.

The data filters 812 can be adapted to discard user-specified data. Specifically, following a visual evaluation of displayed information, including the displayed results of the statistical analysis (e.g., graphs, charts, etc.) and the displayed documents or portions thereof from which the data represented in the displayed results was retrieved, a user may determine that certain retrieved data should be filtered-out (i.e., discarded). For example, a user may request filtering out of specific data that is contained in a duplicate document, that is contained in a near-duplicate document, that matches a specified criteria (e.g., is related to certain subjects, topics, geographies, sources, date ranges, etc.) that was previously known data or that is considered by the user to be uninteresting.

Filtered data can be dynamically re-analyzed by analyzer 814 and re-displayed by display 818 in the same manner, as described above, thereby, allowing a user to more easily and accurately evaluate the data and, specifically, the displayed information in order to identify significant trends and patterns that are suggestive of important, novel, actionable, timely, etc., changes and to recommend actions plans in response to those changes.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

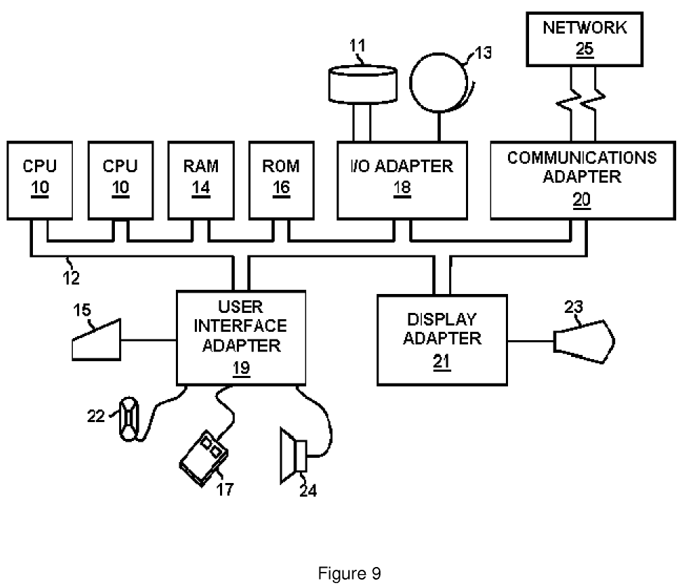

A representative hardware environment for practicing the embodiments of the invention is depicted in FIG. 9. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Therefore, disclosed above, are embodiments of a method of mining data from a high-volume text stream and a method of evaluating that data in order to efficiently and accurately discover significant changes in conditions (e.g., changes in activities, events, associations, affiliations, market preferences, etc.). The data mining technique uses predetermined scenarios that characterize specific changes as well as key variables that are relevant to those scenarios. These variables are input as mining parameters into a data mining tool. Retrieved data is analyzed and the results are evaluated. One technique of evaluating the results includes displaying them in a visual format (e.g., graphs, tables) along with additional information (e.g., lists of documents or portions of documents containing data relevant to the displayed results). A user evaluates the displayed results and additional information in order to identify data that should be filtered, to identify trends and/or patterns in the data, and to assess the trends and/or patterns. Once the trends and/or patterns are assessed, a user can develop and prioritize appropriate action plans. Also, disclosed is an embodiment of a system suitable for implementing such methods.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments of the invention can be practiced with modification within the spirit and scope of the appended claims.

What is claimed is:

1. A method of mining data from a text stream, said method comprising:
receiving variables that are relevant to at least one predetermined scenario that characterizes a change;
applying a data mining algorithm to said text stream in order to retrieve data, wherein said variables comprise parameters for said data mining algorithm; and
performing a statistical analysis of said data.

2. The method of claim 1, wherein said receiving of said variables comprises receiving at least one of subjects, topics associated with each of said subjects, sentiments associated with each of said subjects, geographic locations associated with each of said subjects, source categories, authors and date ranges.

3. The method of claim 1, further comprising filtering said data, wherein said filtering comprises discarding at least one of data contained in a duplicate document, data contained in a near-duplicate document, previously known data, uninteresting data, and data matching a specific criteria.

4. The method of claim 1, further comprising displaying results of said statistical analysis in at least one visual format, wherein said at least one visual format comprises at least one of a graph, a table, a chart, a map, a tabulation, and a diagram.

5. The method of claim 1, further comprising determining statistical significance of results of said statistical analysis within a predetermined threshold and, based on said results, identifying at least one of a trend and a pattern in said data that is suggestive of said change.

6. A method of evaluating data mined from a text stream, said method comprising:
performing a statistical analysis of said data;
displaying information related to said data, wherein said displaying of said information comprises:
displaying results of said statistical analysis in at least one visual format; and
displaying one of portions of documents containing said data, a list of documents containing said data, and at least one document containing said data; and
evaluating said information in order to filter said data and to identify at least one of a trend and a pattern in said data that is suggestive of a change.

7. The method of claim 6, further comprising determining statistical significance of said results within a predetermined threshold.

8. The method of claim 6, further comprising determining a likelihood of said change, potential impacts from said change and a timeframe of said change.

9. The method of claim 8, wherein said potential impacts comprise impacts on one organization as compared to impacts on competitors of said one organization.

10. The method of claim 6, further comprising verifying veracity, validity and timeliness of said data upon which said at least one of said trend and said pattern is based.

11. The method of claim 6, further comprising developing an action plan in response to said change.

12. The method of claim 6, wherein said at least one visual format comprises at least one of a graph, a table, a chart, a map, a tabulation, and a diagram.

13. A system for mining and analyzing data from a text stream, said system comprising:
a user-interface adapted to allow a user to input variables that are relevant to at least one user-identified scenario that characterizes a change;
a data mining tool configured to apply a data mining algorithm to said text stream in order to retrieve data, wherein parameters for said mining algorithm comprise said variables; and,
an analyzer adapted to perform a statistical analysis of said data and produce results.

14. The system of claim 13, wherein said variables comprise at least one of subjects, topics associated with said subjects, sentiments associated said subjects, geographic locations associated with said subjects, source categories, authors and date ranges.

15. The system of claim 13, wherein said analyzer is further adapted to determine statistical significance of said results within a predetermined threshold.

16. The system of claim 13, further comprising a processor adapted to convert said results into at least one visual format; and, a display adapted to display said at least one visual format so that a user can visually identify at least one of a trend and a pattern that is suggestive of said change.

17. The system of claim 16, wherein said at least one visual format comprises at least one of a graph, a table, a chart, a map, a tabulation, and a diagram.

18. The system of claim 16, wherein said at least one visual format comprises user selected dimensions and wherein said user-selected dimensions comprise at least one of subjects, topics associated with each of said subjects, geographic locations associated with each of said subjects, source categories, and date ranges.

19. The system of claim 16, wherein said display is further adapted to simultaneously display, in addition to said at least one visual format, one of portions of documents containing data relevant to said results, a list of documents containing said data relevant to said results, and documents containing said data relevant to said results.

20. The system of claim 13, wherein said data mining tool comprises a set of unstructured text analytics mining algorithms.
